(19) United States
(12) Patent Application Publication
(10) Pub. No.: US 2010/0322570 A1
(43) Pub. Date: Dec. 23, 2010

(54) CONNECTOR HAVING AN OPTICAL MODULE FOR TRANSMITTING OPTICAL MODULE

(75) Inventors: QI-SHENG ZHENG, Kunshan (CN); JIA-YONG HE, Kunshan (CN); ZHENG-GUO SUN, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/818,177

(22) Filed: Jun. 18, 2010

(30) Foreign Application Priority Data
Jun. 18, 2009 (CN) 200910303377.3

(51) Int. Cl. G02B 6/36

(52) U.S. Cl. 385/93

(57) ABSTRACT

A connector having a chamber (101) for insertion of a plug includes an optical module (4) having lenses (45) exposed to the chamber for transmitting optical data; and an insulative housing having a receiving slot (115) located behind the chamber (101) and communicating with the chamber for receiving the optical module (4), and a top wall (111) for covering the receiving slot (115). The top wall has a set of openings passing therethrough for exposing key side edges of the receiving slot to exterior.

### BACKGROUND OF THE INVENTION

1. Field of the Invention

The present invention relates to a connector, more particularly to connectors having an optical module for transmitting optical data.

2. Description of Related Art

At present, Universal Serial BUS (USB) is a widely used input/output interface adapted for many electronic devices, such as personal computer and related peripherals. In 1994, Intel, HP, IBM, NEC etc. together founded USB-IF to define a spec of USB. Nowadays, USB-IF has published several editions for USB, and transmitting rate of USB has becomes higher and higher. As development of electronic industry, higher transmitting rate of USB based connection accessory is needed.

An optical universal serial bus (OUSB) has been disclosed to be adopted for optical data transmission. The OUSB includes a USB connector with a number of lenses embedded in the USB connector and further connected with respective fibers for transmitting optical signal. Therefore, the OUSB can transmit signals up to 10 Gbps. However, as the lens are fixed to the USB connector, and they may fail to mate with counterparts if excessive clearance exits in manufacturing process.

Hence, an improved connector with an optical module assembled thereto is desired to overcome the above problems.

### BRIEF SUMMARY OF THE INVENTION

According to one aspect of the present invention, a connector having a chamber for insertion of a plug comprises: an optical module having lenses exposed to the chamber for transmitting optical data; and an insulative housing having a receiving slot located behind the chamber and communicating with the chamber for receiving the optical module, and a top wall for covering the receiving slot. The top wall has a plurality of openings passing therethrough for exposing key side edges of the receiving slot to exterior.

According to another aspect of the present invention, a connector having a chamber for insertion of a plug comprises an insulative housing having a base portion, a tongue plate extending forwardly into the chamber, and a receiving slot formed in the base portion and located above the tongue plate, the receiving slot being surrounded by a top wall, a bottom wall opposite to the top wall and a pair of side walls at two lateral sides thereof, the receiving slot having side edges formed at the side walls, the top wall having a plurality of openings passing therethrough for exposing key points of the side edges to exterior so that the side edges are identified by a profile projector or other optical measurement tools conveniently; an optical module received in the receiving slot and having lenses exposed to the chamber for transmitting optical data; a plurality contacts disposed on an upper surface of the tongue plate for mating with the plug; and a metal shell shielding the insulative housing.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a connector according to the present invention;

FIG. 2 is a partly exploded view of the connector shown in FIG. 1;

FIG. 3 is similar to FIG. 2, but viewed from another aspect;

FIG. 4 is an exploded view of the connector shown in FIG. 1;

FIG. 5 is similar to FIG. 4, but viewed from another aspect;

FIG. 6 is a cross-sectional view of the connector taken along line 6-6 shown in FIG. 1; and

FIG. 7 is a top view of an insulative housing of the connector shown in FIG. 1.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

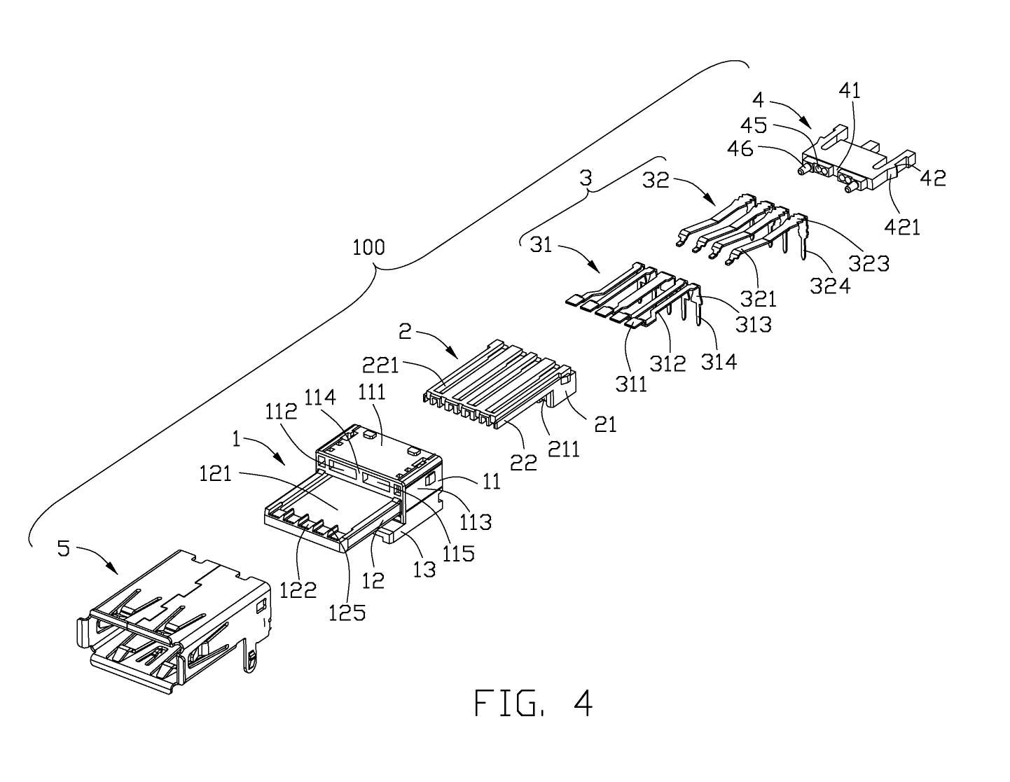

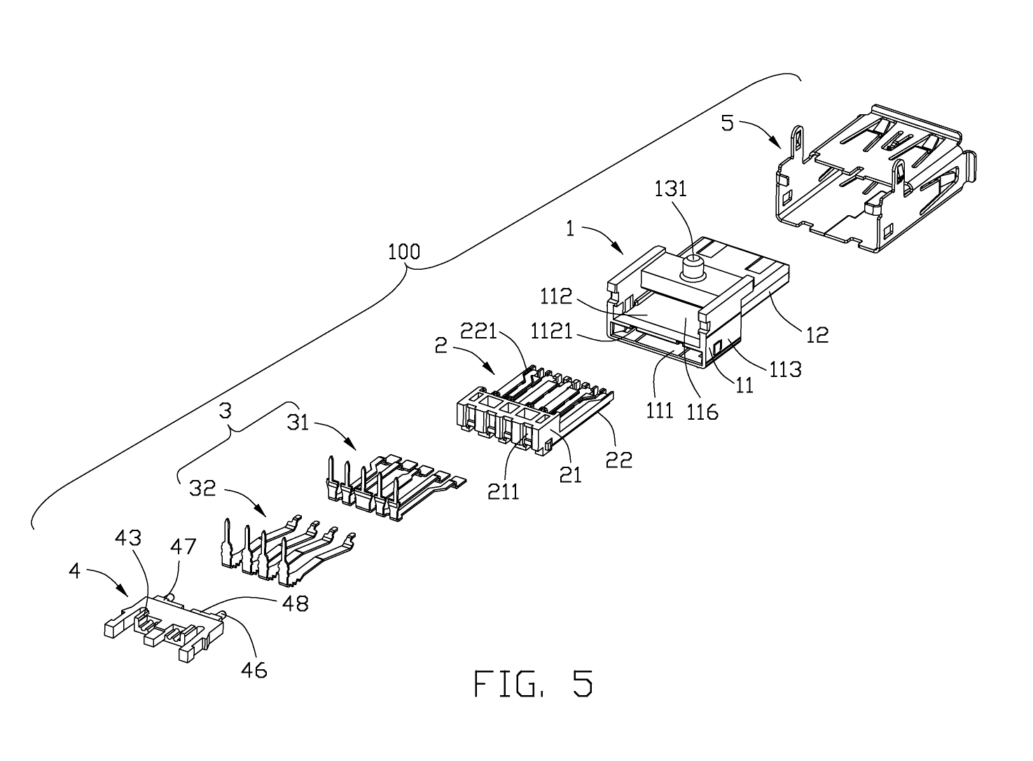

Referring to FIGS. 4 and 5, A connector 100 according to the present invention for being mounted to a printed circuit board (PCB, not shown) is disclosed. The connector 100 is adapted to non-simultaneously receive a standard A-type USB 2.0 plug, a standard A-type USB 3.0 plug, and an optical plug. The connector 100 includes a first insulative housing 1, a second insulative housing 2 coupled to the first insulative housing 1, a set of electrical contacts 3 retained in the second insulative housing 2, a metal shell 5 enveloping the first insulative housing 1 and forming a chamber 101 for receiving a corresponding plug (not shown), and an optical module 4 retained in the first insulative housing 1 for transmitting optical data.

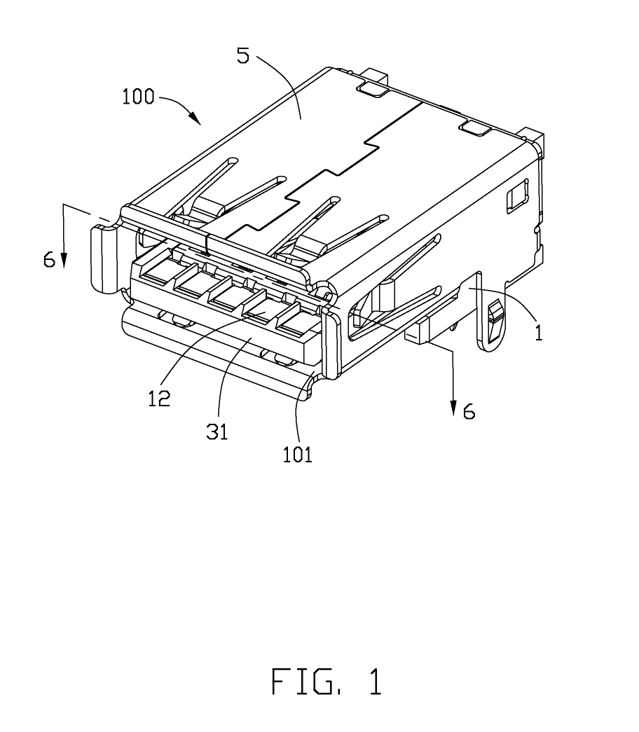

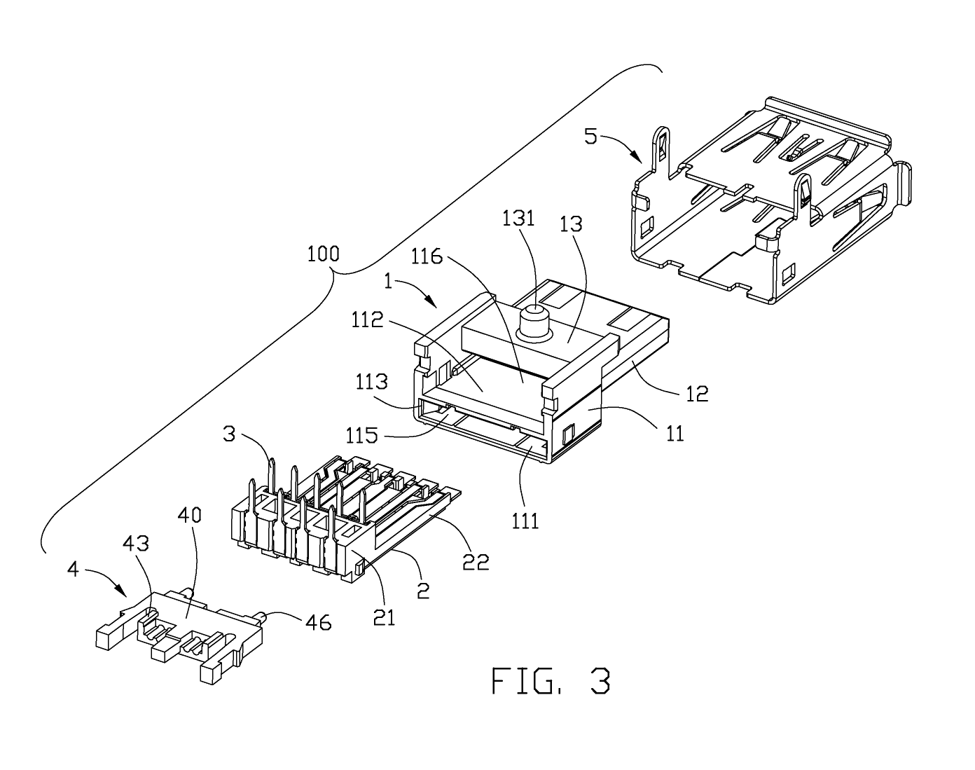

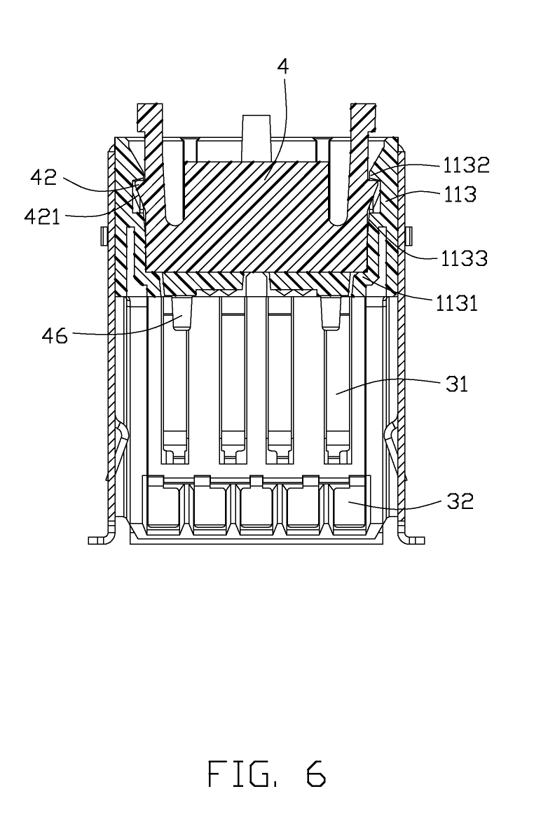

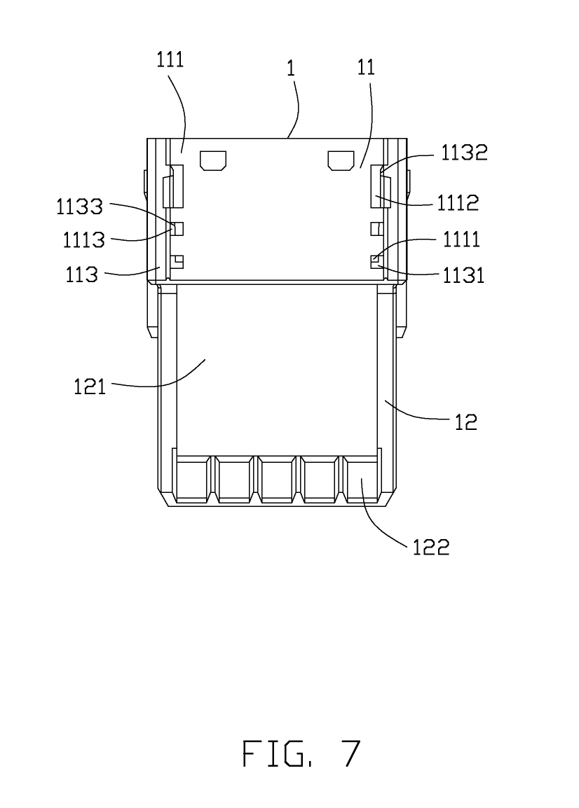

Referring to FIGS. 1-7, the first insulative housing 1 includes a base portion 11, a first protruding portion 12 extending forwardly from an upper portion of the base portion 11, and a standoff 13 extending forwardly from a lower portion of the base portion 11 for supporting the metal shell 5 upwardly. The base portion 11 has a receiving slot 115 for receiving the optical module 4 and locating above the first protruding portion 12, and a retaining slot 116 locating below the receiving slot 115. The receiving slot 115 is formed by a top wall 111, a bottom wall 112 opposite to the top wall 111 and separating the receiving slot 115 from the retaining slot 116, and a pair of side walls 113 locating at two lateral sides thereof. The bottom wall 112 has a pair of cavities 1121 recessed downwardly from an upper surface thereof and communicating with the receiving slot 115. A block 114 is located at front and midst of the receiving slot 115 and connects the top and bottom wall 111, 112 for resisting the optical module 4 backwardly. The top wall 111 has a plurality of openings passing therethrough for exposing key side edges of the receiving slot 115 to exterior. Each side wall 113 has an inclined portion 1133 protruding inwardly therefrom and extending forwardly and obliquely inwardly for guiding the optical module 4 into the receiving slot 115, a resisting portion 1131 protruding inwardly from a front end of the inclined portion 1133 for resisting the optical module 4 backwardly, and a projection 1132 projecting inwardly from a back portion thereof for latching with the optical module 4. The openings on the top wall 111 include a first, second and third openings 1113, 1111, 1112 for exposing the key edges of the inclined portion 1133, the resisting portion 1131 and the projection 1132 respectively. The key edges of the receiving slot 115 are exposed to the exterior through the openings; the dimensions of the receiving slot 115 will be measured via the key edges identified by a profile projector or other optical measurement tools. Therefore, the optical module 4 could be manufactured precisely according to the receiving slot 115 so as to be fitted in the receiving slot 115 dependably and reliably. The first protruding portion 12 has a receiving space 121 recessed downwardly from an upper surface thereof and communicating with the retaining slot 116. The first protruding portion 12 has a set of ribs 125 extending upwardly from the upper surface thereof and located at front of the receiving space 121, and forms a set of grooves 122 exposed to exterior and located between each two adjacent ribs 125. The standoff 13 has a post 131 extending downwardly from a lower face thereof.

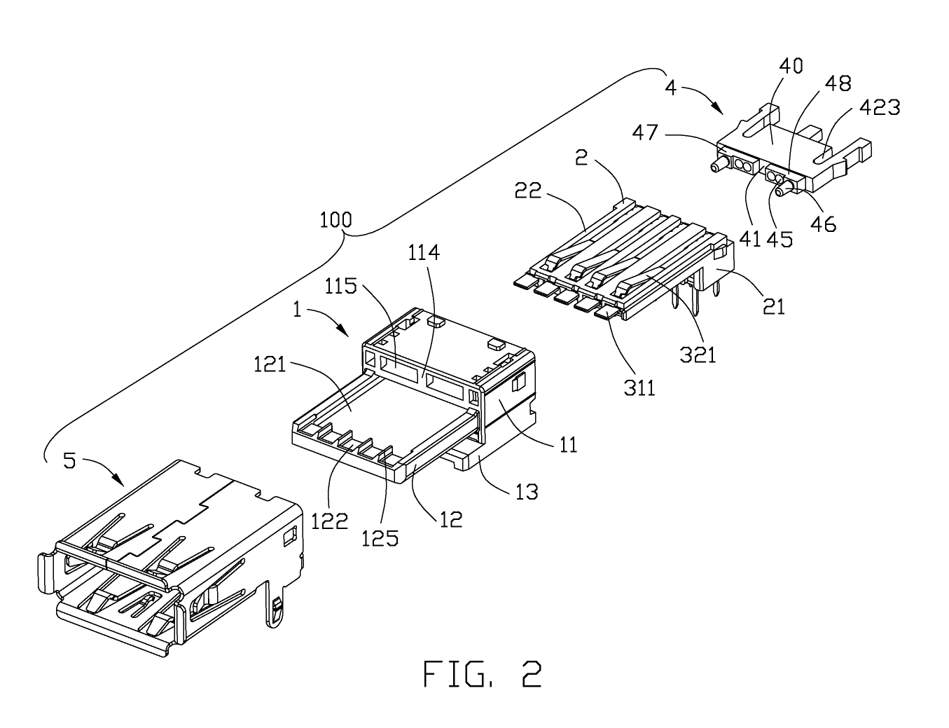

Referring to FIGS. 2-5, the contacts 3 are adapted for USB 3.0 protocol, and include a number of first contacts 31 and a number of second contacts 32. The first contacts 31 include a pair of first differential contacts arranged at a right side thereof, a pair of second differential contacts arranged at a left side thereof, and a first grounding contact located between the pair of first and the pair of second differential contacts. The second contacts 32 are adapted for USB 2.0 protocol and include a power contact arranged at a left side thereof, a second grounding contact arranged at a right side thereof, and a third pair of differential contacts located between the power contact and the third grounding contact.

The second insulative housing 2 includes a main portion 21 retained in the retaining slot 116, and a second protruding portion 22 extending forwardly from the main portion 21 and retained in the receiving space 121. The main portion 21 has a set of securing slots 211 arranged in a front and back surfaces thereof and extending along a height direction of the connector 100. The second protruding portion 22 has a set of passageways 221 arranged in an upper and lower surface thereof and extending along a front-to-back direction. The first contacts 31 include stiff first contacting portions 311 extending forwardly beyond the second protruding portion 22 and received in the corresponding grooves 122, first connecting portions 312 extending downwardly and backwardly from the first contacting portions 311 and along a horizontal plan for being received in the passageways 221 on the lower surface of the second protruding portion 22, first retaining portions 313 bending downwardly from back ends of the first connecting portions 312 and retained in the securing slots 211 on the front surface of the main portion 21, and first tail portions 314 extending downwardly from the corresponding first retaining portions 313 for being mounted on the PCB. The second contacts 32 include resilient second contacting portions 321 retained in the passageways 221 on the upper surface of the second protruding portion 22 and protruding upwardly beyond the upper surface, second retaining portions 323 extending backwardly from back ends of the corresponding second contacting portions 321 for being retained in the corresponding passageways 221 and bending downwardly for being retained in the corresponding securing slots 211, and second tail portions 324 extending downwardly from lower ends of the second retaining portions 323 for being mounted on the PCB. The second contacting portions 321 extend downwardly beyond the first contacting portions 311 and are located behind the first contacting portions 311. The first and second contacts 31, 32 are assembled to the second insulative housing 2 together to form as a contact module for being assembled to the first insulative housing 1. The first insulative housing 1 and the second insulative housing 2 are assembled together to form an insulative housing. The first protruding portion 12 and the second protruding portion 22 are coupled together to form a tongue plate protruding into the chamber 101 for mating with a corresponding plug. In another embodiment, the first insulative housing 1 and the second insulative housing 2 could be integrally formed as the insulative housing, the first contacts 31 could be insert molded into the insulative housing.

Referring to FIGS. 2-6, the optical module 4 is assembled to the first insulative housing 1 and is located above the second insulative housing 2. The optical module 4 has a main body 40, a first and second part 47, 48 extending forwardly from the main body 40, and a recess 41 located between the first and the second part 47, 48. Each of the first and second parts 47, 48 has a pair of lenses 45 disposed on a front end thereof. The optical module 4 has a pair of columniations 46 extending forwardly from the front ends of the respective first and second parts 47, 48 and located at two sides of the lenses 45. The optical module 5 further includes a set of fibers (not shown) assembled in the main body 40 to optically couple with the respective lenses 45. The optical module 4 is assembled to the first insulative housing 1 from a rear end of the first insulative housing 1. The resisting portions 1131 resist front portion of the main body 40 backwardly, and the block 114 is retained in the recess 41 and resists the main body 40 backwardly. The main body 40 has a pair of resilient latches 42 formed at two lateral sides thereof for latching with the projections 1132 to prevent the main body 40 moving backwardly and each defining an inclined guiding face 421 for the optical module 4 entering into the receiving slot conveniently. A slit 423 is formed between the latch 42 and the main body 40, therefore, when the optical module 4 is inserted into the receiving slot 115, the latches 42 are deflected, and the optical module 4 will enter into the receiving slot 115 easily. The main body 40 has a pair of embossments 43 protruding downwardly from a lower face thereof for being retained in the cavities 43 of the bottom wall 112. The lenses 45 are exposed to the chamber 101 so as to optically mate with the corresponding plug. The columniations 46 protrude into the chamber 10 so as to mate with a pair of holes on the corresponding plug.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A connector having a chamber for insertion of a plug, the connector comprising:
an optical module having lenses exposed to the chamber for transmitting optical data; and
an insulative housing having a receiving slot located behind the chamber and communicating with the chamber for receiving the optical module, and a top wall for covering the receiving slot, the top wall having a plurality of openings passing therethrough for exposing key side edges of the receiving slot to exterior.

2. The connector according to claim 1, wherein the top wall is located at top side of the receiving slot, the insulative housing has a bottom wall located at bottom side of the receiving slot and a pair of side walls located at two lateral sides of the receiving slot, the key side edges of the receiving slot are formed on the side walls.

3. The connector according to claim 2, wherein the side walls have inclined portions protruding inwardly therefrom and extending forwardly and obliquely for guiding the optical module into the receiving slot, the openings include first openings for exposing key edges of the inclined portions to the exterior.

4. The connector according to claim 3, wherein the side walls have resisting portions protruding inwardly from front ends of the inclined portion for resisting the optical module backwardly, the openings include second openings for exposing key edges of the resisting portions to the exterior.

5. The connector according to claim 2, wherein the optical module has resilient latches extending at two lateral sides thereof, the side walls have projections protruding inwardly therefrom for latching with the latches to prevent the optical module moving backwardly, the openings include third openings for exposing key edges of the projections to the exterior.

6. The connector according to claim 5, wherein the optical module has slits formed at inner sides of the latches for the latches being deflected easily when the optical module is inserted into the receiving slot.

7. The connector according to claim 2, wherein the optical module has a recess at front thereof, the insulative housing has a block located at front of the receiving slot and connecting the top wall and the bottom wall for being received in the recess.

8. The connector according to claim 2, wherein the optical module has a pair of embossments extending downwardly from a lower surface thereof, the bottom wall has a pair of cavities recessed downwardly from an upper surface thereof for retaining the embossments.

9. A connector having a chamber for insertion of a plug, the connector comprising:
an insulative housing having a base portion, a tongue plate extending forwardly into the chamber, and a receiving slot formed in the base portion and located above the tongue plate, the receiving slot being surrounded by a top wall, a bottom wall opposite to the top wall and a pair of side walls at two lateral sides thereof, the receiving slot having side edges formed at the side walls, the top wall having a plurality of openings passing therethrough for exposing key points of the side edges to exterior so that the side edges are identified by a profile projector or other optical measurement tools conveniently;
an optical module received in the receiving slot and having lenses exposed to the chamber for transmitting optical data;
a plurality contacts disposed on an upper surface of the tongue plate for mating with the plug; and
a metal shell shielding the insulative housing.

10. The connector according to claim 9, wherein the side walls have inclined portions protruding inwardly therefrom and extending forwardly and obliquely for guiding the optical module into the receiving slot, the openings include first openings for exposing key points of the side edges on the inclined portions to the exterior.

11. The connector according to claim 10, wherein the side walls have resisting portions protruding inwardly from front ends of the inclined portion for resisting the optical module backwardly, the openings include second openings for exposing key points of the side edges on the resisting portions to the exterior.

12. The connector according to claim 9, wherein the optical module has resilient latches extending at two lateral sides thereof, the side walls have projections protruding inwardly therefrom for latching with the latches to prevent the optical module moving backwardly, the openings include third openings for exposing key points of the side edges on the projections to the exterior.

13. The connector according to claim 12, wherein the optical module has slits formed at inner sides of the latches for the latches being deflected easily when the optical module is inserted into the receiving slot.

14. The connector according to claim 9, wherein the insulative housing includes a first insulative housing, and a second insulative housing coupled to the first insulative housing, the first insulative housing has a first protruding portion extending forwardly from the base portion, the second insulative housing has a main portion retained in a retaining slot formed in the base portion and a second protruding portion received in a receiving space recessed downwardly from an upper surface of the first protruding portion.

15. The connector according to claim 14, wherein the second protruding portion has a plurality of passageways formed on an upper and lower surfaces thereof, the contacts comprise a plurality of first contacts having resilient first contacting portions received in the passageways on the upper surface of the second protruding portion, and a plurality of second contacts having stiff second contacting portions received in a plurality of grooves formed on an upper surface of the first protruding portion and second connecting portions connecting with the second contacting portions and received in the passageways on the lower surface of the second protruding portion.

16. An electrical connector for use with a plug, comprising:
an insulative housing defining a plug receiving chamber therein;
a receiving slot located behind the chamber and circumstantially defined by opposite top and bottom wall in a vertical direction and opposite side walls in a transverse direction perpendicular to said vertical direction;
a block located between said chamber and said receiving slot in a front-to-back direction perpendicular to both said vertical direction and said transverse direction, and equipped with an opening therethrough in said front-to-back direction, and
an optical module received in the receiving slot and equipped with lenses communicating with the chamber through the opening, said optical module further including at least one deflectable latch located to the corresponding side wall; wherein
the top wall defines a set of through holes to expose a portion of an interior face of said corresponding side wall so as to achieve not only correct interlocking between the latch and the corresponding side wall in said front-to-back direction but also proper engagement between the optical module and the corresponding side wall in said transverse direction, thus assuring a reliable and precise alignment of the lenses with the plug.

17. The electrical connector as claimed in claim 16, further including a metallic shell enclosing the housing to cover the top wall including said through hole.

18. The electrical connector as claimed in claim 16, wherein said set of through holes do not communicate transversely with one another.
